(19) United States
(12) Patent Application Publication
(10) Pub. No.: US 2026/0009934 A1
(43) Pub. Date: Jan. 8, 2026

(54) Waveguide-Based Displays Incorporating Evacuated Periodic Structures

(71) Applicant: DigiLens Inc., Sunnyvale, CA (US)

(72) Inventors: Alastair John Grant, San Jose, CA (US); Hyesog Lee, Sunnyvale, CA (US); Yuyu Li, Sunnyvale, CA (US); Baeddan George Hill, Sunnyvale, CA (US); Gang Li, Sunnyvale, CA (US); Joseph Stephen Thomas Smalley, Sunnyvale, CA (US); Milan Momcilo Popovich, Leicester (GB)

(73) Assignee: DigiLens Inc., Sunnyvale, CA (US)

(21) Appl. No.: 19/111,729

(22) PCT Filed: Sep. 13, 2023
(86) PCT No.: PCT/US2023/074088

§ 371 Date: Mar. 13, 2025

Related U.S. Application Data
(60) Provisional application No. 63/375,498, filed on Sep. 13, 2022.
(60) Provisional application No. 63/490,139, filed on Mar. 14, 2023.

(51) Int. Cl. G02B 5/18; G02B 1/11; G02B 27/01

(52) U.S. Cl. CPC G02B 5/1819; G02B 1/11; G02B 5/1857; G02B 27/0172

(57) ABSTRACT

Disclosed herein is a waveguide based display including: an optically transparent substrate; an input grating including an evacuated periodic structure (EPS) supported by the substrate, wherein the input grating diffracts light into total internal reflection (TIR) within the substrate; a fold grating comprising an EPS or a volume Bragg grating (VBG), wherein the fold grating receives the TIR light and expands the TIR light in a first direction; and an output grating including an EPS or a VBG. The output grating receives the expanded light and outputs the light and the input grating is spatially separated from the fold grating and the output grating.

### CROSS-REFERENCED APPLICATIONS

This application claims priority to U.S. Provisional Application 63/375,498 filed on Sep. 13, 2022 and U.S. Provisional Application 63/490,139 filed on Mar. 14, 2023, the disclosures of which are incorporated by reference in their entirety.

### FIELD OF THE INVENTION

The present invention generally relates to configurations of waveguide-based displays incorporating evacuated periodic structures.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (TIR).

Fabrication of waveguides can include the use of material systems that allow for the recording of holographic optical elements within or on the surface of the waveguides. One class of such material includes polymer dispersed liquid crystal (PDLC) mixtures, which are mixtures containing photopolymerizable monomers and liquid crystals. A further subclass of such mixtures includes holographic polymer dispersed liquid crystal (HPDLC) mixtures. Holographic optical elements, such as volume phase gratings, can be recorded in such a liquid mixture by illuminating the material with two mutually coherent laser beams. During the recording process, the monomers polymerize, and the mixture undergoes a photopolymerization-induced phase separation, creating regions densely populated by liquid crystal (LC) micro-droplets, interspersed with regions of clear polymer. The alternating liquid crystal-rich and liquid crystal-depleted regions form the fringe planes of the grating.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (“AR”) and virtual reality (“VR”), compact head-up displays (“HUDs”) and helmet-mounted displays or head-mounted displays (HMDs) for road transport, aviation, and military applications, and sensors for biometric and laser radar (“LIDAR”) applications. As many of these applications are directed at consumer products, there is a growing requirement for efficient low cost means for manufacturing holographic waveguides in large volumes.

In near-eye displays and display devices it may be beneficial that the overall system including a waveguide and a projector be compact and light weight to enable the user to wear the near-eye display comfortably and to enable the user to perform different tasks in environments where the user moves.

### SUMMARY OF THE INVENTION

In some aspects, the techniques described herein relate to a waveguide based display including: an optically transparent substrate; an input grating including an evacuated periodic structure (EPS) supported by the substrate, wherein the input grating diffracts light into total internal reflection (TIR) within the substrate; a fold grating including an EPS or a volume Bragg grating (VBG), wherein the fold grating receives the TIR light and expands the TIR light in a first direction; and an output grating including an EPS or a VBG, wherein the output grating receives the expanded light and outputs the light, wherein the input grating is spatially separated from the fold grating and the output grating.

In some aspects, the techniques described herein relate to a display, wherein the output grating expands light in a second direction different from the first direction.

In some aspects, the techniques described herein relate to a display, wherein the first direction and the second direction are orthogonal

In some aspects, the techniques described herein relate to a display, wherein fold grating and the output grating are spatially separated from each other.

In some aspects, the techniques described herein relate to a display, wherein the fold grating and the output grating are both VBGs.

In some aspects, the techniques described herein relate to a display, wherein the fold grating is an EPS and the output grating is a VBG.

In some aspects, the techniques described herein relate to a display, wherein the fold grating and the output grating are both EPSs.

In some aspects, the techniques described herein relate to a display, wherein the fold grating is formed on the same side of the substrate as the input grating and the output grating is formed on the opposite side of the substrate from the input grating and the fold grating.

In some aspects, the techniques described herein relate to a display, wherein the fold grating is formed on the opposite side of the substrate as the input grating and the output grating is formed on the same side of the substrate as the input grating.

In some aspects, the techniques described herein relate to a display, wherein the input grating, the fold grating, and the output grating are all formed on the same side of the substrate.

In some aspects, the techniques described herein relate to a display, further including an anti-reflection coating positioned on an opposite side of the substrate from the input grating, the fold grating, and the output grating.

In some aspects, the techniques described herein relate to a display, wherein the fold grating and the output grating at least partially overlap to form an overlapping region.

In some aspects, the techniques described herein relate to a display, wherein the overlapping portions of the fold grating and the output grating are on different layers.

In some aspects, the techniques described herein relate to a display, wherein the fold grating and output grating are both EPSs and the fold grating is positioned on one side of the substrate and the output grating is formed on an opposite side of the substrate.

In some aspects, the techniques described herein relate to a display, wherein the fold grating and the output grating are formed on the same layer such that the overlapping region is a multiplexed region.

In some aspects, the techniques described herein relate to a display, wherein the fold grating and output grating are both VBGs.

In some aspects, the techniques described herein relate to a display, further including a bottom substrate, wherein the fold grating and the output grating are formed between the substrate and the bottom substrate and the input grating is formed the opposite side of the substrate from the fold grating and the output grating.

In some aspects, the techniques described herein relate to a display, further including an anti-reflection layer disposed on the bottom substrate.

In some aspects, the techniques described herein relate to a display, wherein the fold grating and output grating are both EPSs.

In some aspects, the techniques described herein relate to a display, wherein the input grating, the fold grating, and the output grating are all formed on the same side of the substrate.

In some aspects, the techniques described herein relate to a display, further including an anti-reflection coating disposed on the opposite side of the substrate from the input grating, the fold grating, and the output grating.

In some aspects, the techniques described herein relate to a display, wherein the input grating, the fold grating, and the output grating are positioned on the world-side of the substrate and the anti-reflection coating is disposed on the eye-side of the substrate.

In some aspects, the techniques described herein relate to a display, wherein the fold grating and the output grating fully overlap to form an integrated dual expansion (IDA) grating.

In some aspects, the techniques described herein relate to a display, wherein the EPS includes: a plurality of polymer regions; and air gaps between adjacent portions of the plurality of polymer regions.

In some aspects, the techniques described herein relate to a display, wherein the EPS further includes an atomic layer deposition (ALD) coating on the plurality of polymer regions.

In some aspects, the techniques described herein relate to a display, wherein the EPS further includes an optical layer between the substrate and plurality of polymer regions.

In some aspects, the techniques described herein relate to a display, wherein the optical layer forms a homogenous structure with the plurality of polymer regions.

In some aspects, the techniques described herein relate to a display, wherein the VBG of the fold grating or the output grating includes: a plurality of polymer regions; liquid crystal regions between adjacent portions of the plurality of polymer regions.

In some aspects, the techniques described herein relate to a display, wherein the fold grating is a dual interaction grating.

### BRIEF DESCRIPTION OF THE DRAWINGS

The description will be more fully understood with reference to the following figures and data graphs, which are presented as various embodiment of the disclosure and should not be construed as a complete recitation of the scope of the disclosure, wherein:

FIGS. 1A-1D schematically illustrate a process for fabricating deep SRGs or EPSs in accordance with an embodiment.

FIG. 2 is a flowchart of a method for forming deep SRGs from a HPDLC periodic structure formed on a transparent substrate in accordance with an embodiment of the invention.

FIG. 3A illustrates a cross sectional schematic view of an exemplary embodiment of a polymer-air periodic structure implemented on a waveguide.

FIG. 3B illustrates a cross sectional schematic view of a polymer-air periodic structure in accordance with an embodiment of the invention.

FIGS. 4A-4B schematically illustrate a waveguide including all-VBG spatially separated input grating, fold grating, and output grating in accordance with many embodiments.

FIGS. 5A-5B schematically illustrate a waveguide including all-VBG gratings with overlapped fold grating and output grating in accordance with many embodiments.

FIGS. 6A-6B schematically illustrate a waveguide including all-VBG gratings comprising multiplexed (MUX) fold grating and output grating having a common overlap region in the same grating layer in accordance with many embodiments.

FIGS. 7A-7B schematically illustrate a waveguide including an EPS input grating and VBG spatially separated fold grating and output grating in accordance with many embodiments.

FIGS. 8A-8B schematically illustrate a waveguide including an EPS input grating and multiplexed VBG fold grating and output grating in accordance with many embodiments.

FIGS. 9A-9B schematically illustrate a waveguide including an EPS input grating, a EPS fold grating, and an VBG output grating in accordance with many embodiments.

FIGS. 10A-10B schematically illustrate a waveguide including an EPS input grating and spatially separated EPS fold grating and output grating supported by an optical substrate in accordance with many embodiments.

FIGS. 11A-11B schematically illustrate a waveguide including an EPS input grating and partially overlapping EPS fold grating and EPS output grating supported to opposing faces of a substrate in accordance with many embodiments.

FIGS. 12A-12B schematically illustrate a waveguide including an EPS input grating and multiplexed overlapping EPS fold grating and EPS output grating, all three gratings may be supported by one face of a substrate, in accordance with many embodiments.

FIG. 12C illustrates a cross sectional image of the waveguide described in connection with FIGS. 12A-12B including an AR coating on the opposite surface of the substrate to the EPS input grating and the multiplexed overlapping EPS fold grating and EPS output grating.

FIG. 13A schematically illustrates a plan view of a waveguide including an EPS input grating, a surface relief grating (SRG) fold grating, and a SRG output grating in accordance with many embodiments.

FIG. 13B schematically illustrates a plan view of a waveguide including an EPS input grating, SRG fold grating, and VBG output grating.

### DETAILED DESCRIPTION

The present disclosure relates to diffractive waveguides and in particular to diffractive waveguides including at least one grating including an evacuated periodic structure (EPSs). Examples of EPSs are disclosed in U.S. Pat. Pub. No. 2021/0063634, entitled “Evacuating bragg gratings and methods of manufacturing” and filed Aug. 28, 2020, PCT Pub. No. WO 2022015878, entitled “Nanoparticle-based holographic photopolymer materials and related applications” and filed Jul. 14, 2021, and U.S. Pat. Pub. No. 2022/0283376, entitled “Evacuated Periodic Structures and Methods of Manufacturing” and filed Mar. 7, 2022, which are hereby incorporated by reference in their entirety.

Periodic structure (e.g. gratings) may be utilized on waveguides in order to provide a variety of functions. These periodic structure may include angle multiplexed gratings, color multiplexed gratings, fold gratings, dual interaction gratings, rolled K-vector gratings, crossed fold gratings, tessellated gratings, chirped gratings, gratings with spatially varying refractive index modulation, gratings having spatially varying grating thickness, gratings having spatially varying average refractive index, gratings with spatially varying refractive index modulation tensors, and gratings having spatially varying average refractive index tensors. In specific examples, gratings for diffraction of various polarizations of light (e.g. S-polarized light and P-polarized light) may be beneficial. It may be specifically advantageous to have a grating which diffracts either S-polarized light or P-polarized light. Specific applications for this technology include waveguide-based displays such as augmented reality displays and virtual reality displays. One example is input gratings which may be used to input one or both of S-polarized light or P-polarized light into the waveguide. However, in many cases, it may be advantageous to have a grating which diffracts either S-polarized light and P-polarized light. For example, waveguide displays using unpolarized light sources such as OLED light sources produce both S-polarized and P-polarized light and thus it would be advantageous to have gratings which can diffract both S-polarized and P-polarized light.

One specific class of gratings includes surface relief gratings (SRGs) which may be used to diffract either P-polarized light or S-polarized light. Another class of gratings are surface relief gratings (SRGs) which are normally P-polarization selective, leading to a 50% efficiency loss with unpolarized light sources such as organic light emitting diodes (OLEDs) and light emitting diodes (LEDs). Combining a mixture of S-polarization diffracting and P-polarization diffracting gratings may provide a theoretical 2× improvement over waveguides using P-diffracting gratings only. Thus, it would be advantageous to have a high efficiency S-polarization diffraction grating. In many embodiments, an S-polarization diffracting grating can be provided by a periodic structure formed in a holographic photopolymer. One periodic structure includes a grating such as a Bragg grating. In some embodiments, an S-polarization diffracting grating can be provided by a periodic structure formed in a holographic polymer dispersed liquid crystal (HPDLC) with birefringence altered using an alignment layer or other processes for realigning the liquid crystal (LC) directors. In several embodiments, an S-polarization diffracting periodic structure can be formed using liquid crystals, monomers, and other additives that naturally organize into S-diffracting periodic structures under phase separation. In some embodiments, these HPDLC periodic structures may form deep SRGs which have superior S-polarization diffraction efficiency. Deep SRGs may be configured to provide high efficiency for both S-polarization and P-polarization light. HPDLC periodic structures formed using typical LC and monomer material components may have LC molecular structures that are preferentially aligned for high P diffraction efficiency. After the LC has been removed, the polarization dependence of the resulting SRG may depend on properties of the resulting polymer grating. The relative efficiencies for S-polarization and P-polarization light may be tuned to provide high S-polarization or P-polarization diffraction efficiency or high diffraction efficiency at both polarizations based on grating thickness.

One class of deep SRGs are polymer-air SRGs or evacuated periodic structure (EPSs) which may exhibit high S-diffraction efficiency (up to 99%) and low P-diffraction efficiency and may be implemented as input gratings for waveguides. The EPSs may be evacuated Bragg gratings (EBGs). Such periodic structures can be formed by removing the liquid crystal from HPDLC periodic structures formed from holographic phase separation of a liquid crystal and monomer mixture. Deep SRGs formed by such a process typically have a thickness in the range 1-3 micrometers with a fringe spacing 0.35 to 0.80 micrometers. In some embodiments, the ratio of grating depth to fringe spacing may be 1:1 to 5:1. As can readily be appreciated, such gratings can be formed with different dimensions depending on the specific requirements of the given application.

Periodic structures of any complexity can be made using interference or master and contact copy replication. In some embodiments, after removing the LC, the SRGs can be back filled with a material with different properties to the LC. This allows a periodic structure with modulation properties that are not limited by the grating chemistry needed for grating formation.

In some embodiments, the backfill material may not be a LC material. In some embodiments, the backfill material may have a higher index of refraction than air which may increase the angular bandwidth of a waveguide. The backfill material may have index (based on ordinary or extraordinary indices in the case of birefringent materials) higher or lower than the polymer matrix. In several embodiments, the deep SRGs can be partially backfilled with LC to provide a hybrid SRG/periodic structure. Alternatively, in some embodiments, the refill step can be avoided by removing just a portion of the LC from the LC rich regions of the HPDLC to provide a hybrid SRG/periodic structure. The refill approach has the advantage that a different LC can be used to form the hybrid periodic structures. The materials can be deposited using an inkjet deposition process.

In some embodiments, the methods described herein may be used to create photonic crystals. Photonic crystals may be implemented to create a wide variety of diffracting structures including periodic structures such as Bragg gratings. Periodic structures may be used as diffraction gratings to provide functionality including but not limited to input gratings, output gratings, beam expansion gratings, and gratings for diffracting more than one primary color. A photonic crystal can be a three-dimensional lattice structure that can have diffractive capabilities not achievable with basic periodic structures (such as Bragg gratings formed from alternating high index and low index lamina). Photonic crystals can include many structures including all 2-D and 3-D Bravais lattices. Recording of such structures may benefit from more than two recording beams. Photonic crystals may include polymer diffracting elements (such as rods) immersed in air or, alternatively, elongated voids in a polymer matrix. The structures may have more complex geometries depending on the recording arrangement and number of interfering beams. In many cases, the structure resulting from exposure and phase separation may be modified using etching processes.

In some embodiments, waveguides incorporating photonic crystals can be arranged in stacks of waveguides, each having a grating prescription for diffracting a unique spectral bandwidth or angular bandwidth. In many embodiments, a photonic crystal formed by liquid crystal extraction provides a deep SRG. In many embodiments, a deep SRG formed using a liquid crystal extraction process can typically have a thickness in the range 1-3 micron with a fringe spacing 0.35 micron to 0.80 micron. The fringe spacing may be a Bragg fringe spacing. In many embodiments, the condition for a deep SRG is characterized by a high grating depth to fringe spacing ratio. In some embodiments the condition for the formation of a deep SRG is that the grating depth can be approximately twice the grating period. It should be emphasized here that, although S-polarization diffracting deep SRGs are described in the present application, deep SRGs can, as will be discussed below, provide a range of polarization response characteristics depending on the thickness of the grating prescription and, in particular, the grating depth. Deep SRGs can also be used in conjunction with conventional Bragg gratings to enhance the color, uniformity and other properties of waveguide displays.

The disclosure provides a method for making a surface relief grating that can offer very significant advantages over nanoimprint lithographic process particularly for slanted gratings. Periodic structures of any complexity can be made using interference or master and contact copy replication. In some embodiments after removing the LC the SRG can be back filled with a material with different properties to the LC. This allows a periodic structure with modulation properties that are not limited by the grating chemistry needed for grating formation. In some embodiments the SRGs can be partially backfilled with LC to provide a hybrid SRG/periodic structure. Alternatively, in some embodiments, the refill step can be avoided by removing just a portion of the LC from the LC rich regions of the HPDLC to provide a hybrid SRG/periodic structure. The refill approach has the advantage that a different LC can be used to form the hybrid grating. The materials can be deposited using an inkjet process. In some embodiments, the refill material may have a higher index of refraction than air which may increase diffraction efficiency of the periodic structure.

While this disclosure has been made in the context of fabricating deep SRGs, it is appreciated that many other grating structures may be produced using the techniques described herein. For example, any type of SRG including SRGs in which the grating depth is smaller than the grating frequency (e.g. Raman-Nath gratings) may be fabricated as well.

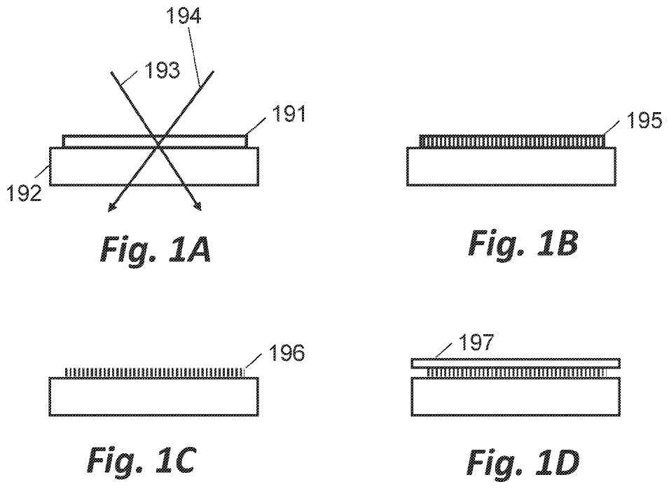

FIGS. 1A-1D schematically illustrate a process for fabricating deep SRGs or EPSs in accordance with an embodiment. FIG. 1A illustrates a first step of a method for fabricating an EPS in which a mixture 191 of monomer and inert fluid (e.g. liquid crystal) is deposited on a transparent substrate 192 and exposed to holographic exposure beams 193,194. The holographic exposure beams 193, 194 may be deep UV beams. In some examples, the mixture 191 may also include at least one of a photoinitiator, a coinitiator, a multifunctional thiol, adhesion promoter, surfactant, and/or additional additives.

The mixture 191 may include nanoparticles. The mixture 191 may include photoacids. The mixture 191 may be a monomer diluted with a non-reactive polymer. The mixture 191 may include more than one monomer. In some embodiments, the monomer may be isocyanate-acrylate based or thiolene based. In some embodiments, the liquid crystal may be a full liquid crystal mixture or a liquid crystal single. A liquid crystal single may only include a portion of a full liquid crystal mixture. Various examples, liquid crystal singles may include one or all of cyanobiphenyls, alkyl, alkoxy, cyanobiphenyls, and/or terphenyls. The liquid crystal mixture may include a cholesteric liquid crystal. The liquid crystal mixture may include chiral dopants which may control the grating period. The liquid crystal mixture may include photo-responsive and/or halogen bonded liquid crystals. In some embodiments, liquid crystal may be replaced with another substance that phase separates with the monomer during exposure to create polymer rich regions and substance rich regions. Advantageously, the substance and liquid crystal singles may be a cost-effective substitute to full liquid crystal mixtures which are removed at a later step as described below.

In some embodiments, the liquid crystal in the mixture 191 may have a difference between an extraordinary refractive index and an ordinary refractive index of less than 0.01. In some embodiments, the liquid crystal in the mixture 191 may have a difference between an extraordinary refractive index and an ordinary refractive index of less than 0.025. In some embodiments, the liquid crystal in the mixture 191 may have a difference between an extraordinary refractive index and an ordinary refractive index of less than 0.05.

FIG. 1B conceptually illustrates the result from FIG. 1A which includes an HPDLC Bragg grating 195 formed on a transparent substrate using the holographic exposure beams. The holographic exposure beams may transform the monomer into a polymer in some areas. The holographic exposure beams may include intersecting recording beams and include alternating bright and dark illumination regions. A polymerization-driven diffusion process may cause the diffusion of monomers and inert in opposite directions, with the monomers undergoing gelation to form polymer-rich regions (in the bright regions) and the inert fluid becoming trapped in a polymer matrix to form inert rich regions (in the dark regions).

FIG. 1C conceptually illustrates a second step that for fabricating a deep polymer surface relief grating 196 or EPS in which the inert fluid is removed from an HPDLC periodic structure of FIG. 1B to form a polymer surface relief grating. Advantageously, a polymer surface relief grating 196 may include a large depth with a comparatively small grating period in order to form a deep SRG. The inert fluid may be removed by washing with a solvent such as isopropyl alcohol (IPA). The solvent may be strong enough to wash away the inert fluid but weak enough to maintain the polymer. In some embodiments, the solvent may be chilled below room temperature before washing the grating.

In some embodiments, a further post treatment of the EPSs might be used to remove more of the weak polymer network regions. In some embodiments, a plasma ashing may be performed, to reduce or eliminate vestigial polymer networks. In some embodiments the plasma ashing may be used to remove the initial inert fluid such that inert fluid may be removed without the use of a solvent but merely by plasma ashing.

In some embodiments, post coating the EPSs with a very thin atomic layer of high index material can enhance the diffractive properties (e.g. the refractive index modulation) of the grating. The coating may be a metallic layer or a dielectric layer. One such process, Atomic Layer Deposition (ALD), involves coating the gratings with TiO₂ or ZnO₂.

In some embodiments, after curing, removal of the inert material to form the polymer grating, and ashing, thermal reflow may be used to modify the geometry and surface quality of the etched feature. The thermal reflow may include modification of the shape of the grating structure using polymer melting and mass transport. When heated over its glass transition temperature, the polymer changes into a viscous state. A surface of least energy (surface of minimum area) is formed under surface tension forces. This process typically occurs at high temperatures but may also take place at moderate temperatures if the polymer melt is sufficiently viscous. Reflow may result in a curving of the faces of the polymer structure. The resulting curved diffractive elements are potentially useful for expanding the angular response of the grating structure.

In some embodiments, a protective layer is applied after the fabrication of the EPS. FIG. 1D illustrates an example step of a method for fabricating a polymer surface relief grating in which the polymer surface relief grating is covered with a protective layer 197.

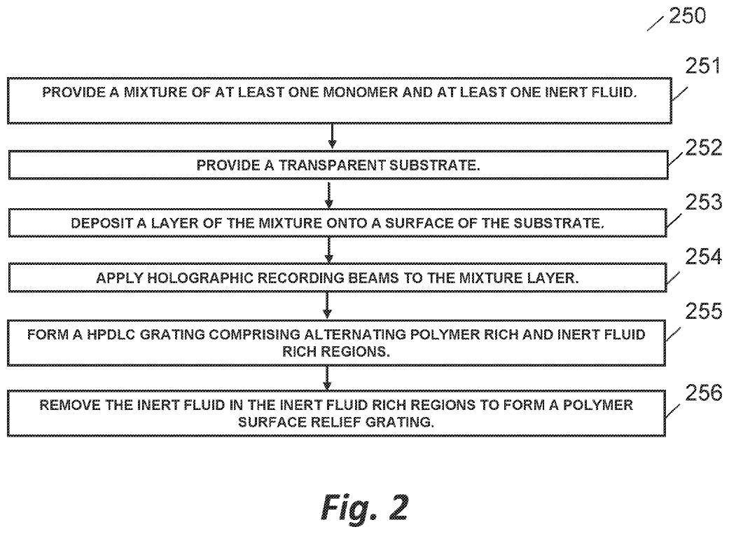

FIG. 2 is a flowchart of a method for forming deep SRGs from a HPDLC periodic structure formed on a transparent substrate in accordance with an embodiment of the invention. As shown, a method 250 of forming deep SRGs or EPSs is provided. Referring to the flow diagram, the method 250 includes providing (251) a mixture of at least one monomer and at least one inert fluid. The at least one monomer may include an isocyanate-acrylate monomer or thiolene. For example, the mixture may include a liquid crystal and a thiolene based photopolymer. In some embodiments, the mixture may include a liquid crystal and an acrylate-based photopolymer. In some embodiments, the at least one liquid crystal may be a full liquid crystal mixture or may be a liquid crystal single which may include only a portion of the liquid crystal mixture such as a single component of the liquid crystal mixture. In some embodiments, the at least one liquid crystal may be substituted for a solution which phase separates with the monomer during exposure. The criteria for such a solution may include ability to phase separate with the monomer during exposure, ease of removal after curing and during washing, and ease of handing. Example substitute solutions include solvents, non-reactive monomers, inorganics, and nanoparticles.

Providing the mixture of the monomer and the liquid crystal may also include mixing one or more of the following with the at least one monomer and the liquid crystal: initiators such as photoinitiators or coinitiators, multifunctional thiol, dye, adhesion promoters, surfactants, and/or additional additives such as other cross linking agents. This mixture may be allowed to rest in order to allow the coinitiator to catalyze a reaction between the monomer and the thiol. The rest period may occur in a dark space or a space with red light (e.g. infrared light) at a cold temperature (e.g. 20° C.) for a period of approximately 8 hours. After resting, additional monomers may be mixed into the monomer. This mixture may be then strained or filtered through a filter with a small pore size (e.g. 0.45 μm pore size). After straining, this mixture may be stored at room temperature in a dark space or a space with red light before coating.

Next, a transparent substrate can be provided (252). In certain embodiments, the transparent substrate may be a glass substrate or a plastic substrate. In some embodiments, the transparent substrate may be a flexible substrate to facilitate roll to roll processing. In some embodiments, the EPS may be manufactured on a flexible substrate through a roll to roll process and then peeled off and adhered to a rigid substrate. In some embodiments, the EPS may be manufactured on a flexible substrate and a second flexible release layer may be peeled off and discarded which would leave the EPS on a flexible layer. The flexible layer may be then bonded to another rigid substrate.

A layer of the mixture can be deposited or coated (253) onto a surface of the substrate. The layer of mixture may be deposited using inkjet printing. In some embodiments, the mixture is sandwiched between the transparent substrate and another substrate using glass spacers to maintain internal dimensions. A non-stick coating may be applied to the other substrate before the mixture is sandwiched. The non-stick coating may include a fluoropolymer such as OPTOOL UD509 (produced by Daikin Chemicals), Dow Corning 2634, Fluoropel (produced by Cytonix), and EC200 (produced by PPG Industries, Inc). Holographic recording beams can be applied (254) to the mixture layer. holographic recording beams may be a two-beam interference pattern which may cause phase separation of the inert fluid and the polymer. In response to the holographic recording beam, the liquid monomer changes to a solid polymer whereas the neutral, inert fluid or non-reactive substance (e.g. LC) diffuses during holographic exposure in response to a change in chemical potential driven by polymerization. While LC may be one implementation of the neutral, non-reactive substance, other substances may also be used. The substance and the monomer may form a miscible mixture prior to the holographic exposure and become immiscible upon holographic exposure.

After applying the holographic recording beams, the mixture may be cured. The curing process may include leaving the mixture under low-intensity white light for a period of time until the mixture fully cures. The low intensity white light may also cause a photo-bleach dye process to occur. Thus, a HPDLC periodic structure having alternating polymer rich and inert fluid rich regions can be formed (255). In some embodiments, the curing process may occur in two hours or less. After curing, one of the substrates may be removed exposing the HPDLC periodic structure. Advantageously, the non-stick coating may allow the other substrate to be removed while the HPDLC periodic structure remaining.

HPDLC periodic structure may include alternating sections of inert fluid rich regions and polymer regions. The inert fluid in the inert fluid rich regions can be removed (256) to form polymer surface relief gratings or EPSs which may be used as deep SRGs. The inert fluid may be removed by gently immersing the grating into a solvent such as IPA. The IPA may be chilled and may be kept at a temperature lower than room temperature while the grating is immersed in the IPA. The periodic structure may be then removed from the solvent and dried. In some embodiments, the periodic structure is dried using a high flow air source such as compressed air. After the LC is removed from the periodic structure, a polymer-air surface relief grating is formed.

As shown in FIG. 1D, the formed surface relief grating can further be covered with a protective layer. In some instances, the protective layer may be a moisture and oxygen barrier with scratch resistance capabilities. In some instances, the protective layer may be a coating that does not fill in air gap regions where LC that was removed once existed. The coating may be deposited using a low temperature process. In some implementations, the protective layer may have anti-reflective (AR) properties. The coating may be a silicate or silicon nitride. The coating process may be performed by a plasma assisted chemical vapor deposition (CVD) process such as a nanocoating process. The coating may be a parylene coating. The protective layer may be a glass layer. A vacuum or inert gas may fill the gaps where LC that was removed once existed before the protective layer is applied. In some embodiments, the coating process may be integrated with the inert fluid removal process (256). For example, a coating material may be mixed with the solvent which is used to wash the inert fluid from the periodic structure.

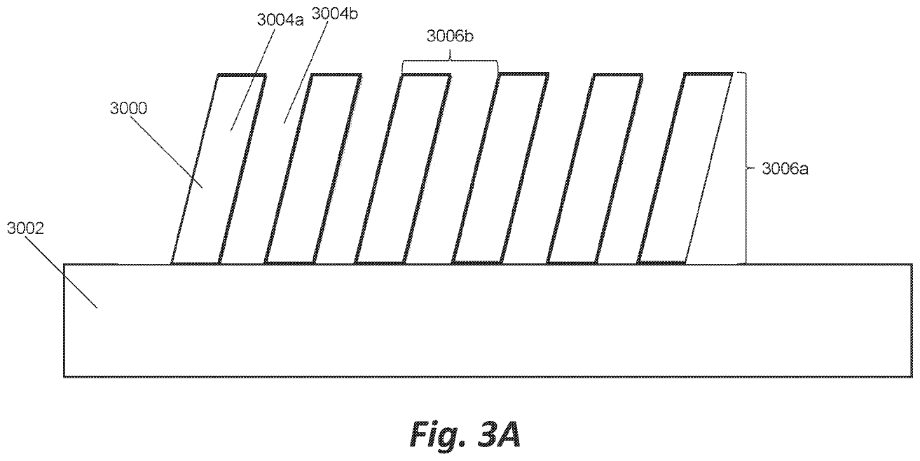

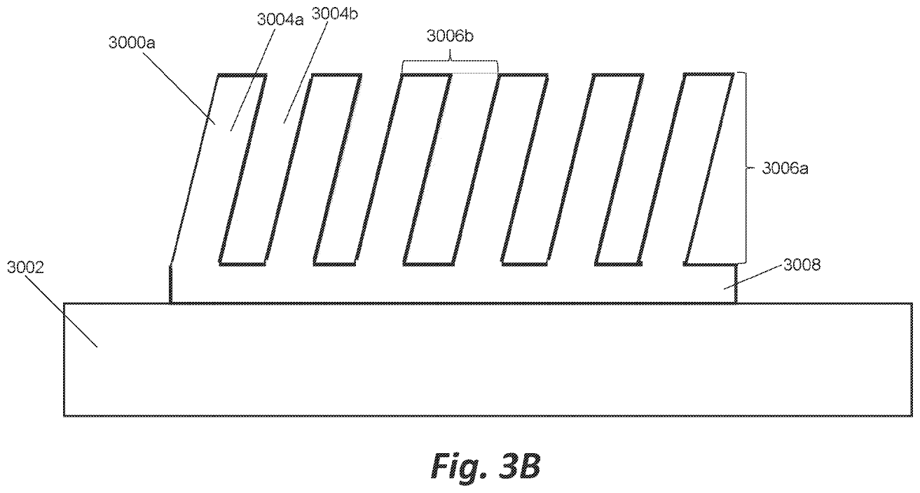

FIG. 3A illustrates a cross sectional schematic view of an exemplary embodiment of a polymer-air periodic structure 3000 implemented on a waveguide 3002. The polymer-air periodic structure 3000 includes periodic polymer sections 3004a. Adjacent polymer sections 3004a sandwich air sections 3004b. The air sections 3004b are sandwiched by polymer sections 3004a. The air sections 3004b and polymer sections 3004a have different indexes of refraction. Advantageously, the polymer-air periodic structure 3000 may be formed with a high grating depth 3006a to Bragg fringe spacing 3006b ratio which may create a deep SRG. As illustrated, the polymer sections 3004a and the air sections 3004b extend all the way to the waveguide 3002 to directly contact the waveguide 3002. As illustrated, there may be no bias layer between the polymer sections 3004a and the air sections 3004b and the waveguide 3002. As discussed previously, deep SRGs may exhibit many beneficial qualities such as high S-diffraction efficiency which may not be present within the typical SRGs.

In one example, a polymer-air periodic structure 3000 may have a Bragg fringe spacing 3006b of 0.35 μm to 0.8 μm and a grating depth of 1 μm to 3 μm. in some embodiments, a grating depth of 1 μm to 3 μm may be too thick for most EPS (with ashing and ALD) for fold and output gratings for waveguide applications, where leaky structures are needed. Values in the ranges of 0.1 μm to 0.5 μm might be more suitable for leaky structures, particularly when modulation is increased with ashing and ALD. For example, Input structures may include a depth in the range of 0.4 μm up to 1 μm. Structures with a depth from 1 μm to 3 μm may be advantageous for display cases, and structures even taller may be advantageous for non-display applications. Structures with half period (e.g. a critical dimension) to height ratio of 7:1 or even 8:1 have been demonstrated with advantageous effects.

In some embodiments, the polymer sections 3004a may include at least some residual liquid crystal when the liquid crystal is not completely removed during step 256 described in connection with FIG. 2. In some embodiments, the presence of residual LC within the polymer rich regions may increase refractive index modulation of the final polymer SRG. In some embodiments, the air sections 3004b may include some residual liquid crystal if the liquid crystal is not completely removed during step 256 from these air sections 3004b. In some embodiments, by leaving some residual liquid crystal within the air sections 3004b, a hybrid grating may be created.

In some embodiments, an optical layer 3008 may also exist between the polymer sections 3004a and the air sections 3004b and the waveguide 3002. The optical layer 3008 may be a bias layer between the polymer sections 3004a and the air sections 3004b and the waveguide 3002. FIG. 3B illustrates a cross sectional schematic view of a polymer-air periodic structure 3000a in accordance with an embodiment of the invention. The polymer-air periodic structure 3000a includes many identically numbered components with the polymer-air periodic structure 3000 of FIG. 3A. The description of these components is applicable with the polymer-air periodic structure 3000a described in connection with FIG. 3B and this description will not be repeated in detail. As illustrated, an optical layer 3008 is positioned between the polymer sections 3004a and the air sections 3004b and the waveguide 3002. The waveguide may include a waveguide 3002 and an optical layer 3008 (e.g. the bias layer) sandwiched by the waveguide 3002 and the polymer periodic structure and wherein the polymer periodic structure extends all the way to the optical layer to directly contact the optical layer. The polymer periodic structure includes the polymer sections 3004a and the air sections 3004b.

In some examples, an optical layer 3008 may be formed when gratings are formed using Nano Imprint Lithography (NIL). The grating pattern may be imprinted in a resin leaving a thin layer underneath the period structure which is a few microns thick. This optical layer 3008, which may be a few microns in thickness, may reside between the waveguide (e.g. glass) substrate and the period grating layer and may not be removed without damaging the NIL grating structure. When the bias refractive index is lower than that of the waveguide substrate the bias layer may confine light for some field angles (furthest from TIR in the waveguide) to the high index substrate which may be analogous to cladding on an optical fiber core. This may cause the field supported in the waveguide to be clipped and hence not supported by the waveguide. Elimination of the bias layer can offer grating coupling from a high index substrate with a grating structure of lower index than the substrate which may not be possible with the bias layer present.

In formation of EPSs, since the phase separation process leading to grating formation may take place through the entire holographic recording material layer, gratings may be formed throughout the volume of the cell gap resulting in no optical layer 3008. The elimination of the optical layer 3008 can allow wider fields of view to be realized when using high index waveguide substrates. Wide field of view angular content may be propagated with lower refractive index grating structures. EPSs may deliver similar optical performance characteristics to nanoimprinted SRGs by offering taller structures albeit at lower peak refractive index. This may open up the possibility of low-cost fabrication of diffractive structures for high efficiency waveguides.

Although the elimination of the optical layer 3008 from a waveguide grating device can offer the field of view benefits as discussed above, in some embodiments, an optical layer 3008 may be present in EPSs. The present disclosure allows for waveguide grating devices with or without the optical layer 3008.

In some embodiments, having the optical layer 3008 can be an advantage as the evanescent coupling between the waveguide and the grating is a function of the indices of the gratings structure (e.g. the grating depth the angles of the faces making up the structure and the grating depth), the waveguide core, and the optical layer 3008 (if present). In some embodiments, the optical layer 3008 may be used as a tuning parameter for optimizing the overall waveguide design for better efficiency and bandwidth. Unlike nanograting SRGs, a bias layer used with an EPS may not be of the same index as the grating structure. The optical layer 3008 may be made of the same material as the polymer sections 3004a such that the polymer sections 3004a and the optical layer 3008 form one homogenous structure. The optical layer 3008 may also be a different material than the polymer sections 3004a.

Further details of EPS structures and fabrication methods are disclosed in U.S. Pat. Pub. No. 2023/0078253, entitled “Evacuated Gratings and Methods of Manufacturing” and filed Sep. 12, 2022, U.S. Pat. Pub. No. 2023/0266512, entitled “Nanoparticle-Based Holographic Photopolymer Materials and Related Applications” and filed Jan. 13, 2023, and U.S. Pat. Pub. No. 2022/0283376, entitled “Evacuated Periodic Structures and Methods of Manufacturing” and filed Mar. 7, 2022, which are hereby incorporated by reference in their entirety for all purposes. An EPS or a volume grating can also be configured as a grating operating in the Raman-Nath regime. Unlike Bragg gratings which diffract with high efficiency into the first order, Raman Nath gratings are characterized by higher orders. While a Raman-Nath grating is often physically thin, the transition from Raman-Nath and Bragg regimes also depends on index modulation and may occur for relatively large grating thicknesses.

Waveguide Architectures Including All-VBG Discrete Gratings that are Spatially Separated in the Waveguide Plane

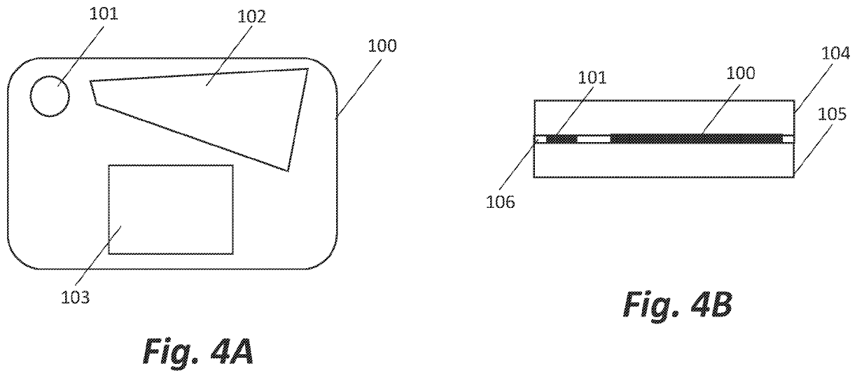

FIGS. 4A-4B schematically illustrate a waveguide 100 including all-VBG spatially separated input grating 101, fold grating 102, and output grating 103, in accordance with many embodiments. FIG. 4A is a plan view whereas FIG. 4B is a cross-sectional view of the waveguide 100. In many embodiments, the gratings 101, 102, 103 are formed in a common thin holographic photopolymer grating layer 106 sandwiched by optical substrates 104, 105. The photopolymer layers may be between 1-3 micron in thickness. In many embodiments the substrates 104, 105 are glass. In other embodiments, the substrate 104, 105 may be plastic substrates. In many embodiments, each substrate 104, 105 is between 0.2 mm to 0.5 mm in thickness. Volume Bragg Gratings (VBGs) may be recorded into a holographic photopolymer which may be an isotropic material or an anisotropic material such as a HPDLC recording material including at least one monomer and at least one birefringent material. In many embodiments, the birefringent material may be a liquid crystal. In many embodiments, the VBG may be recorded into a mixture of monomer and an inert material such as nanoparticles. In many embodiments, at least one of the VBGs may be a transmission grating. As will be discussed below, VBGs are a subset of volume gratings, which can also be configured as thin (Raman-Nath) gratings. In other embodiments, at least one of the VBGs may be a reflection grating.

The input grating 101 may perform input coupling of input light. The fold grating 102 may provide a first beam expansion. The output grating 103 may provide a second beam expansion orthogonal to the first beam expansion and extract the light towards an exit pupil.

In various embodiment, any or all of the gratings 101, 102, 103 may be plane gratings (e.g., structures formed from parallel planar high index and low index lamina). In various embodiment, any or all of the gratings 101, 102, 103 may be non-slanted gratings. In many embodiments, any or all of the gratings 101, 102, 103 may be slanted gratings using grating slant angles (equivalent to K-vectors) to optimize the waveguide efficiency. In many embodiments, at least one or all of the gratings 101, 102, 103 may have rolled K-Vectors (RKVs). In many embodiments, in which the gratings are intended to provide optical power the gratings may comprise diffracting features with curvature in at least one plane orthogonal to the grating substrate. In many embodiments, the fold grating 102 may be configured to provide dual interaction to enhance angular bandwidth. Examples of dual interaction gratings are discussed in U.S. Pat. No. 9,632,226, entitled “Waveguide grating device” and issued Apr. 25, 2017, which is hereby incorporated by reference in its entirety for all purposes.

In many embodiments, an antireflection (AR) coating may be applied to at least one of the outer surfaces of one of the substrates 104, 105 to maximize see through transmission. In many embodiments, the prescriptions of the output grating 103 and the AR coating may be designed to minimize eyeglow which is unintended light ejected towards the world. In many embodiments, eyeglow may be image containing. In many embodiments, the diffraction efficiency angular bandwidth, transmission, spectral and polarization characteristics of the output grating 103, and the spectral bandwidth, polarization, transmission and angular efficiency of the AR coating may be optimized to minimize eyeglow. In various embodiments, one or more of the gratings 101, 102, 103 may be formed from isotropic or anisotropic materials to optimize optical efficiency. In many embodiments, one or more of the gratings 101, 102, 103 may include at least one isotropic material grating and at least one anisotropic material grating. Many of the above VBG attributes may also be applied to EPS gratings in the embodiments to be discussed.

One or more of the gratings 101, 102, 103 may be VBGs with high efficiency. In many embodiments, the VBGs may be recorded in materials that exhibit low haze after exposure and curing. Waveguide architectures based on VBGs may include the limitation that two glass substrates may be required for each waveguide. This may arise from the need to protect the grating layer from the environment. It would be advantageous to have waveguide architectures which include only one optical substrate. Benefits include simplification of the manufacture process and thinner waveguide layers. The latter is important in stacked waveguide configurations. Examples of waveguide architectures which include only one optical substrate are described below.

All-VBG discrete grating architectures may reduce eyeglow but have low diffraction efficiency. Output gratings based on VBGs may benefit from the high efficiencies and angular selectivity of Bragg structures, resulting in most of the incident light being directed into the eyebox.

Waveguide Architecture Including All-VBG, with Overlapped Fold and Output Gratings in the Waveguide Plane

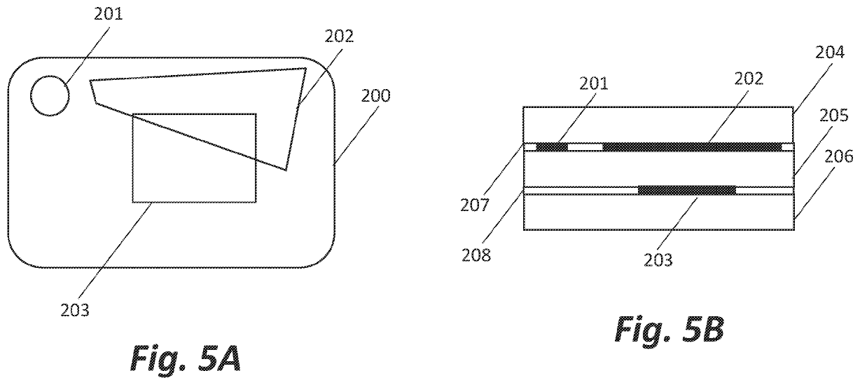

FIGS. 5A-5B schematically illustrate a waveguide 200 including all-VBG gratings with overlapped fold grating 202 and output grating 203 in accordance with many embodiments. FIG. 5A is a plan view whereas FIG. 5B is a cross-sectional view of the waveguide 200. The waveguide also includes an input grating 201 spatially separated from the fold grating 202 and the output grating 203. In the fold grating 202 and output grating 203, overlap occurs when the fold grating 202 and output grating 203 are viewed from the eyebox center. The fold grating 202 and the output grating 203 are not multiplexed into a single grating. In many embodiments, the fold grating 202 is formed in a first thin holographic photopolymer grating layer 207 sandwiched by optical substrates 204, 205. The output grating 203 is formed in a second thin holographic photopolymer grating layer 208 sandwiched by optical substrates 205, 206. Overlapping the fold grating 202 and output grating 203 reduces the overall footprint of the waveguide. AR coatings may be applied to at least one of the outer reflecting surfaces of the two outer substrates 204, 206. While a partially overlapping fold grating 202 and output grating 203 is shown, some embodiments may include the fold grating 202 and the output grating 203 fully overlapping. For example, the fold grating 202 and the output grating 203 may form an integrated dual expansion (IDA) grating. Examples of IDA gratings are discussed in U.S. Pat. Pub. No. 2020/0264378, entitled “Methods and Apparatuses for Providing a Holographic Waveguide Display Using Integrated Gratings” and filed Feb. 18, 2020, and U.S. Pat. Pub. No. 2022/0283377, entitled “Wide Angle Waveguide Display” and filed Apr. 15, 2022, which are hereby incorporated by reference in their entirety for all purposes.

The embodiments of FIGS. 5A-5B have all the advantages of the device described in connection with FIGS. 4A-4B but with a more compact footprint. Both outer surfaces may be AR coated to maximize see through transmission and minimize eyeglow. In some embodiments, the AR coating may have spatially varying properties (e.g. reflectivity, spectral, angular, and/or polarization response), the properties being matched to the properties of grating regions overlapping the coating. Such configuration may be useful for controlling eyeglow and or glare resulting from external light being reflected into the eyebox after interaction with gratings and/or undergoing reflection at optical surface of the waveguide substrates. Eyeglow is light from the waveguide that is directed towards the world side, rather than towards the eye. Eyeglow is typically expressed as a percentage of light towards the eye side. One issue with the embodiments of FIGS. 5A-5B is that three optical substrates per waveguide may be required, resulting in greater manufacturing complexity and cost. Glass tolerances may be tighter to retain same total thickness variation (TTV) as a two-substrate design.

Waveguide Architecture Including All-VBG Gratings, with Multiplexed Fold and Output Gratings in the Same Region and Same Grating Layer

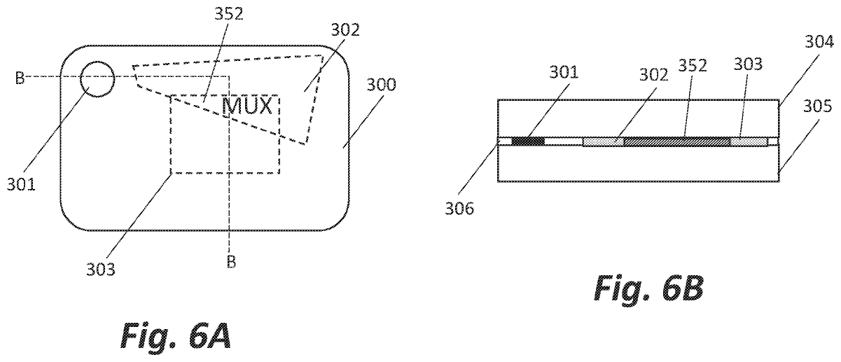

FIGS. 6A-6B schematically illustrate a waveguide 300 including all-VBG gratings comprising multiplexed (MUX) fold grating 302 and output grating 303 having a common overlap region in the same grating layer in accordance with many embodiments. FIG. 6A is a plan view of the waveguide 300. FIG. 6B is a cross-sectional view of the waveguide 300 through line B-B shown in FIG. 6A. The fold grating 302 and the output grating 303 may be formed in a common thin holographic photopolymer grating layer 306 sandwiched by optical substrates 304, 305. The fold grating 302 and the output grating 303 may include a multiplexed region 352. The multiplexed region 352 of the fold grating 302 and output grating 303 may be achieved by multiplexing the fold grating 302 and the output grating 303 into a single overlapping region, resulting in a reduction of the overall footprint as the device described in connection with FIGS. 5A-5B. The waveguide 300 includes an input grating 301 which is provided on the same layer as the fold grating 302 and the output grating 303.

AR coatings may be applied to the outer reflecting surfaces of the substrates 304, 305 to maximise transmission and minimize eyeglow. Multiplexing the fold grating 302 and output grating 303 reduces the footprint of the gratings similar to the device described in connection with FIGS. 5A-5B while utilizing just two substrates per waveguide. The multiplexed fold grating 302 and output grating 303 may reduce available modulation for each prescription which may reduce diffraction efficiency of each grating. In many embodiments, the modulation loss may be mitigated by trading off efficiency against other waveguide performance metric such as luminance uniformity, color uniformity across the grating to optimize uniformity of illumination and color. The multiplexing modulation may be controlled (e.g., by varying coat thickness and compositions) during the holographic material deposition stage using data obtained from reverse ray tracing.

While a partially MUX fold grating 302 and output grating 303 are shown, in some embodiments these gratings may be fully overlapping which would mean that the multiplexed region 352 would include the whole fold grating 302 and the output grating 303. For example, the fold grating 302 and the output grating 303 may form an IDA grating. Examples of IDA gratings are discussed in U.S. Pat. Pub. No. 2020/0264378, entitled “Methods and Apparatuses for Providing a Holographic Waveguide Display Using Integrated Gratings” and filed Feb. 18, 2020, and U.S. Pat. Pub. No. 2022/0283377, entitled “Wide Angle Waveguide Display” and filed Apr. 15, 2022, which are hereby incorporated by reference in their entirety for all purposes.

Waveguide Architecture Including EPS Input Grating with VBG Fold and Output Gratings with All Gratings Spatially Separated in the Waveguide Plane

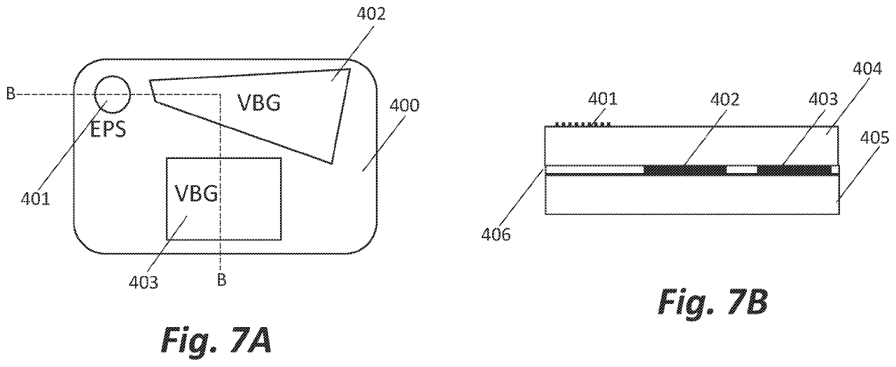

FIGS. 7A-7B schematically illustrate a waveguide 400 including an EPS input grating 401 and VBG spatially separated fold grating 402 and output grating 403 in accordance with many embodiments. FIG. 7A is a plan view of the waveguide 400. FIG. 7B is a cross-sectional view of the waveguide 400 across line B-B of FIG. 7A. The fold grating 402 and output grating 403 are formed in a thin holographic photopolymer grating layer 406 sandwiched by optical substrates 404, 405. The spatially separated VBG gratings may be efficient. The EPS input grating 401 may be formed on an outer surface of one of the substrates 404, 405.

The fold grating 402 and the output grating 403 are spatially separate VBG gratings which maximizes available refraction index modulation for each grating allowing greater diffraction efficiency for each grating. The use of EPS input grating 401 enables higher input coupling efficiency and, in many applications, may provide higher diffraction efficiency and a wider diffraction efficiency angular bandwidth. In many embodiments, an EPS input grating 401 may be optimized for high efficiency simultaneous coupling of both S and P polarization states. The EPS input grating 401 may be used for non-polarized projection sources such as micro-LED. In many embodiments, an EPS input grating 401 results in a smaller footprint than an equivalent prescription RKV input grating.

EPS input gratings may have high angular bandwidth and high diffraction efficiency resulting from high modulation depth. This may be important for reducing the stray light at the input grating that might otherwise propagate into eyeglow paths.

### Waveguide Architectures Including an EPS Input Grating and Multiplexed VBG Fold and Output Gratings

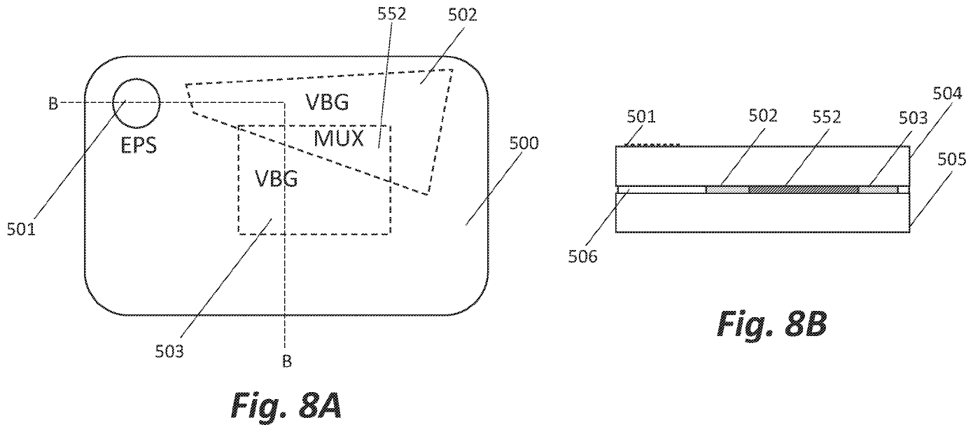

FIGS. 8A-8B schematically illustrate a waveguide 500 including an EPS input grating 501 and multiplexed VBG fold grating 502 and output grating 503 in accordance with many embodiments.

The multiplexed fold grating 502 and output grating 503 are formed in a common thin holographic photopolymer grating layer 506 sandwiched by optical substrates 504, 505. A multiplexed region 552 may include both a portion of the fold grating 502 and the output grating 503. The fold grating 502 and the output grating 503 may be formed in a single layer while still overlapping to save space. The EPS input grating 401 may be formed on an outer surface of one of the substrates 504, 505. While a partially MUX fold grating 502 and output grating 503 are shown, it is understood that these gratings may be fully overlapping. For example, these gratings may form an IDA grating.

As for the earlier discussed embodiments, multiplexing the EPS fold grating 502 and output grating 503 minimizes the waveguide footprint. The included two substrates 504, 505 reduces the waveguide thickness however there is a reduction of waveguide efficiency due to the sharing of refractive index modulation between the fold grating 502 and output grating 503.

Waveguide Architectures Including EPS Input and EPS Fold Gratings with VBG Output Grating, where the Fold and Output Gratings Spatially Overlap

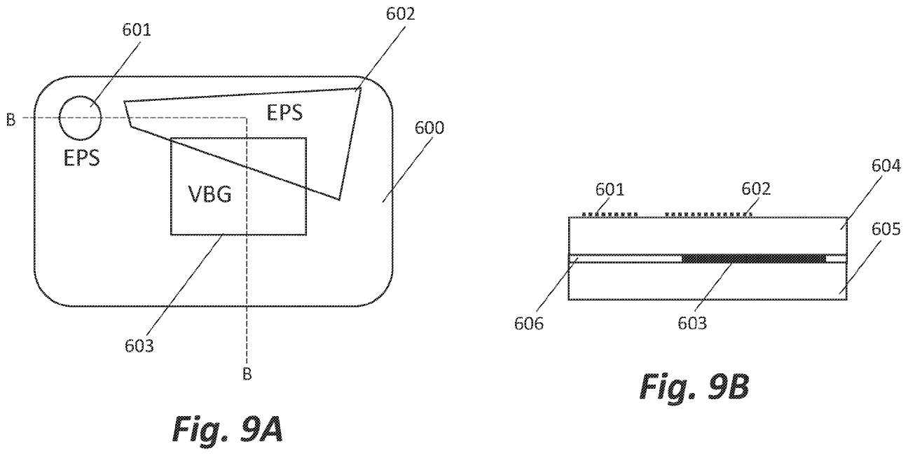

FIGS. 9A-9B schematically illustrate a waveguide 600 including an EPS input grating 601, a EPS fold grating 602, and an VBG output grating 603 in accordance with many embodiments. FIG. 9A is a plan view of the waveguide 600. FIG. 9B is a cross-sectional view of the waveguide 600 through line B-B shown in FIG. 9A. The waveguide includes two substrates 604, 605 sandwiching one VBG layer 606 which includes the VBG output grating 603. The EPS input grating 601 and EPS fold grating 602 may be disposed on the outside surface of waveguide. In some embodiments, the EPS input grating 601 and EPS fold grating 602 are disposed on the same one of the two substrates 604, 605. In some embodiments, the EPS input grating 601 and the EPS fold grating 602 are disposed on different ones of the two substrates 604, 605. While a partially overlapping fold grating 602 and output grating 603 are shown, in some embodiments, these gratings may be fully overlapping. For example, these gratings may form an IDA grating. IDA gratings may occur where the participating gratings are not in exact overlap. In many embodiments, light that make it to the eyebox after undergoing folding, beam expansion and extraction by the IDA grating may benefit from the angular bandwidth enhancement that results when fold gratings are configured for dual interaction gratings.

Spatially overlapped fold grating 602 and output grating 603 may provide a smaller waveguide footprint. An EPS input grating 601 enables improved input coupling efficiency, higher diffraction efficiency, wider diffraction efficiency angular bandwidth, and simultaneous high efficiency coupling of both S and P polarization states. The EPS input grating 601 may be utilized for non-polarized projection sources such as micro-LED. An EPS input grating 601 may provide few beam-grating interactions compared with the multiple interactions of light within leaky fold grating 602 and output grating 603 used in two-dimensional beam expansion. As a result, the haze from the EPS input grating 601 has only a little impact on overall waveguide ANSI contrast. ANSI refers to American National Standards Institute. ANSI contrast is a system level measure of contrast measured using a checkerboard pattern. The fold grating 602 may be unslanted (or minimally slanted) resulting in less haze and allowing easier manufacture.

One disadvantage is that two glass substrates are required per waveguide. It has also been discovered that fold EPS gratings may prevent the use of AR coating over the fold grating. The overlap of the fold grating and output grating may also add to eyeglow. In order to achieve mitigate these issues, the EPS fold grating may be positioned on the non-eyeside of the waveguide for lower eyeglow.

Waveguide Architectures with EPS Input, Fold and Output Gratings and All Gratings Spatially Separated in the Waveguide Plane

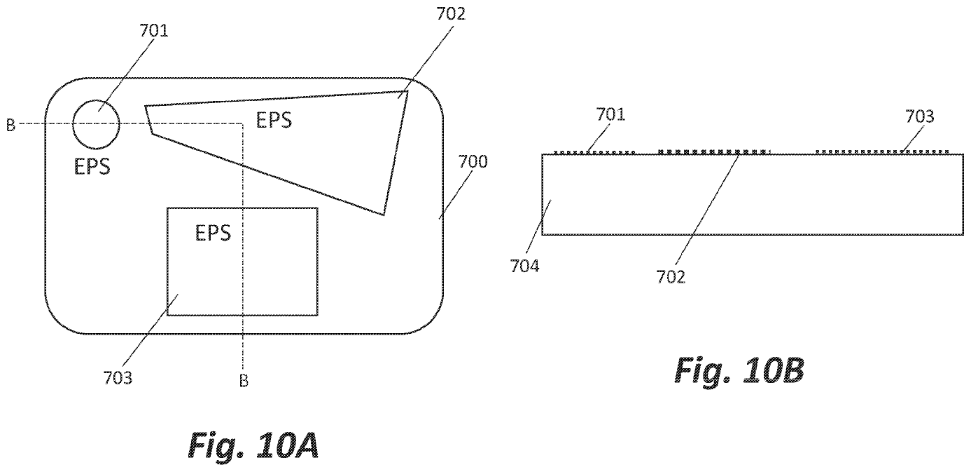

FIGS. 10A-10B schematically illustrate a waveguide 700 including an EPS input grating 701 and spatially separated EPS fold grating 702 and output grating 703 supported by an optical substrate 704, in accordance with many embodiments. FIG. 10A is a plan view of the waveguide 700. FIG. 10B is a cross-sectional view of the waveguide 700 through line B-B shown in FIG. 10A. All three EPS gratings 701, 702, 703 may formed on the same surface of the substrate 704. It should be noted that, in various embodiments, the EPS gratings 701, 702, 703 may be applied to either or both sides of the waveguide 700. For example, the input grating 701 and fold grating 702 may be on one side of the substrate 704 and the output grating 703 on the opposing side of the substrate 704. In some embodiments, more than the three EPS gratings 701, 702, 703 may be supported by the single waveguide substrate 704. For example, in many embodiments, the substrate 704 may support two spatially overlapped EPS input gratings, two spatially overlapped EPS fold gratings and two spatially overlapped EPS output gratings, that is six EPS grating in total. Such configuration may offer further enhanced angular response and, potentially, provide wider field of view coverage, and/or higher efficiency. The scope for adding more EPS gratings structures to the waveguide may be limited by the need to minimise haze to maintain ANSI contrast requirements.

An all-EPS grating architecture offers the benefits of single substrate and greater efficiency and brightness resulting from higher index modulation. The higher index modulation may be set by the depth of the diffracting features as opposed to refractive index modulation when compared to VBGs. When the three EPS gratings 701, 702, 703 are positioned on one side of the substrate 704, the other side of the substrate 704 may be AR coated to improve see through transmission and minimize eyeglow. AR coating in output grating region can only be on non-EPS side. The AR coating on one face of the substrate 704 may improve see through transmission and eyeglow compared to non-AR coated waveguides.

The EPS gratings 701, 702, 703 may be on the non-eye side. However, this may reduce eyeglow performance when waveguides are stacked to form a multi waveguide assembly. For example, there may a first waveguide stacked on top of a second waveguide. The second waveguide may be further from the eye than the first waveguide. In this case light directed towards the eye from the second waveguide will pass through the non-AR coated EPS output grating of the first waveguide. This may generate a reflection which adds to the eye glow signature.

EPS may also enable better eyeglow/efficiency performance from fold gratings used in discrete grating architectures. All EPS solution including etching, modification potentially best solution because of potential for combining high reflection efficiency, and angular bandwidths that can be optimized over the expected eyeglow range.

### Waveguide Architecture Comprising an EPS Input Grating, Fold and Output Gratings, Fold and Output Gratings Overlapped but on Opposite Outer Surfaces of the Waveguide

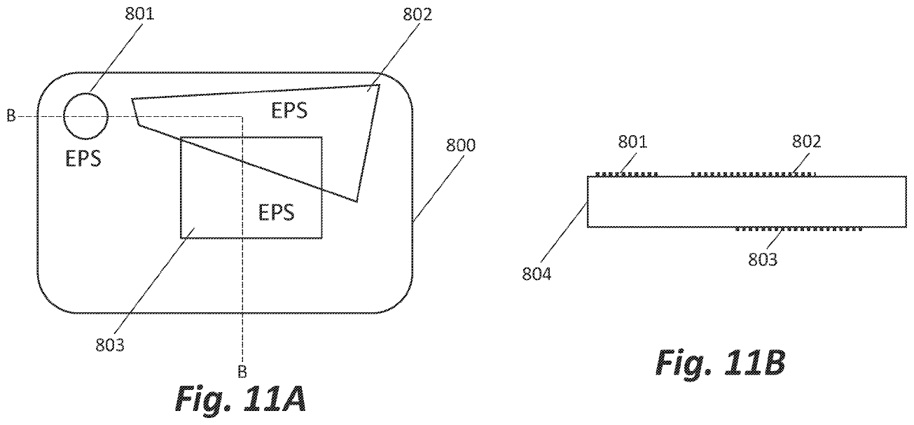

FIGS. 11A-11B schematically illustrate a waveguide 800 including an EPS input grating 801 and partially overlapping EPS fold grating 802 and EPS output grating 803 supported to opposing faces of a substrate 804, in accordance with many embodiments. FIG. 11A is a plan view of the waveguide 800. FIG. 11B is a cross-sectional view of the waveguide 800 through line B-B shown in FIG. 11A. While a partially overlapping fold grating 802 and output grating 803 are shown, in some embodiments, these gratings may be fully overlapping. For example, these gratings may form an IDA grating.

The overlapping of the of the fold grating 802 and output grating 803 results in a smaller footprint waveguide. The all-EPS grating architecture offers the benefits of single substrate and greater efficiency and brightness resulting from higher index modulation. Overlapping the EPS fold grating 802 and the EPS output grating 803 means that AR coatings may not be easily/directly applied over the grating areas. The absence of AR coatings may degrade see through transmission and increases eyeglow. EPS structures include low haze in order to achieve high ANSI contrast. Reducing haze in slanted EPS gratings presents challenges due to the many interactions required for exit pupil expansion the and increase in scatter resulting from the smaller grating separations of EPS slanted structures (slanted fringes are closer together than unslanted structures and represent a greater total surface area for a given grating volume with a given surface period).

Waveguide Architectures Including EPS Input, Fold and Output Gratings with the Fold and Output Gratings Overlapped and Multiplexed

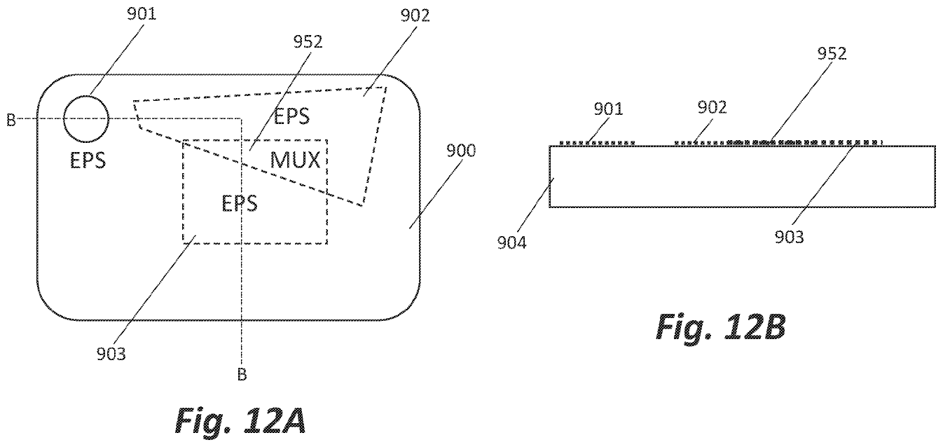

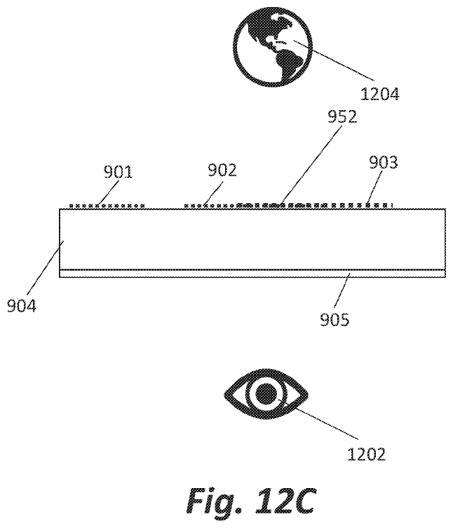

FIGS. 12A-12B schematically illustrate a waveguide 900 including an EPS input grating 901 and multiplexed overlapping EPS fold grating 902 and EPS output grating 903, all three gratings may be supported by one face of a substrate 904, in accordance with many embodiments. FIG. 12A is a plan view of the waveguide 900. FIG. 12B is a cross-sectional view of the waveguide 900 through line B-B shown in FIG. 12A. The EPS fold grating 902 and the EPS output grating 903 overlap in a multiplexed region 952. While a partially overlapping fold grating 902 and output grating 903 are shown, in some embodiments, these gratings may be fully overlapping. For example, these gratings may form an IDA grating.

A single waveguide substrate may provide a small, compact footprint. Multiplexing may allow the EPS fold grating 902 and the EPS output grating 903 to be on a single layer which may provide lower eyeglow. For a single waveguide, it has been discovered that the lowest eyeglow may occur when the EPS multiplexed grating 902, 903 is on the non-eye side of the substrate. A single multiplexed fold/output grating (e.g. when the fold grating 902 and the output grating 903 are completely overlapping) may minimize the number of grating interactions reducing haze and increasing ANSI contrast. Examples of harmonic gratings produced through multiplexed EPS gratings are discussed in Int. Pat. App. No. PCT/US2023/068830, entitled “Harmonic Gratings Utilizing Evacuated Periodic Structures” and filed Jun. 21, 2023, which is hereby incorporated by reference in its entirety.

EPS expansion/output gratings with high slant angles (˜50 degrees) may be effective for controlling eyeglow. EPS with etching modification can produce clearly defined structures in multiplexed gratings for use in integrated dual expansion (IDA) beam expansion/extraction architectures, resulting in lower eyeglow than VBG fold/output gratings. For the above reasons EPS may also be more suitable than VBG for overlapped gratings in IDA waveguides. Examples of waveguides including IDA architectures are described in Int. Pat. App. No. PCT/US2023/068830 which is previously incorporated by references.

In many embodiments, an antireflection (AR) coating may be applied to the surface of the substrate 904 opposite to the EPS input grating 901 and the multiplexed overlapping EPS fold grating 902 and EPS output grating 903. The AR coating may maximize see through transmission while minimizing eyeglow. FIG. 12C illustrates a cross sectional image of the waveguide 900 described in connection with FIGS. 12A-12B including an AR coating on the opposite surface of the substrate 904 to the EPS input grating 901 and the multiplexed overlapping EPS fold grating 902 and EPS output grating 903. In many embodiments, the prescriptions of the output grating 903 and the AR coating 905 may minimize eyeglow which is unintended image containing light ejected towards the world rather than the eye. In many embodiments, the diffraction efficiency angular bandwidth, transmission, spectral and polarization characteristics of the output grating 903, and the spectral bandwidth, polarization, transmission and angular efficiency of the AR coating 905 may be optimized to minimize the eyeglow.

As illustrated, the AR coating 905 may be positioned on the side of the substrate 904 facing the eye 1202 whereas the EPS input grating 901 and the multiplexed overlapping EPS fold grating 902 and EPS output grating 903 may be positioned on the side of the substrate 904 facing the world 1204 which may provide the configuration that best mitigates eyeglow.

When all the gratings 901, 902, 903 are positioned on the world side of the substrate 904, the eye-side of the substrate 904 may be include various coatings include the AR coating 905 across the entirety of the surface. The AR coating 905 may also be positioned within selected regions targeting specific eyeglow paths. The AR coating 905 may include varying coating specifications across the surface to provide high AR efficiency for certain angular ranges, or wavelength ranges, for example. There may be other coatings on the eye-side of the substrate 904 with polarization selective prescriptions and/or wavelength selective prescriptions for use in association with the AR coating 905. The coating properties may be designed to work in association with the diffraction efficiency, angular bandwidth, transmission, spectral, and polarization characteristics of the output grating 903, with the grating and coating properties compensating for each other to achieve a specific eye glow performance. A protective coating may be applied over the coatings on the eye-side of the substrate 904 to provide protection during the holographic processing of the world-side of the substrate 904. Composite coating structures may also be designed to minimize the glare entering the waveguide from the world-side at the same time as controlling eye glow. The composite coating structures may be facilitated when the glare is associated with directions that differ from the directions associated with the eye glow allow coating solutions based on spatially varying angular and spectral bandwidth to be used for eye glow and glare control.

The AR coating may have spatial variations of reflectivity dependent on angle, wavelength, polarization etc., to control eyeglow and may control glare from external sources. The composite nature could be engineered by varying material deposition (composition, thickness) spatially during coating deposition or by using multiple coating layers each having different composition/index and thickness. Multilayer coatings can be designed to operate over larger wavelength and angle bands than single layer coatings.

Lower reflectivity over large angular and spectral bandwidths can be achieved using multiple coating layers configured such that reflections from the layer surfaces undergo maximal destructive interference. For example, in one configuration a quarter-wave thick higher-index layer may be sandwiched by a low-index layer and the waveguide substrate. The reflection from all three interfaces produces destructive interference and anti-reflection. The thickness of the coatings may be used to fine tune the AR response coatings. Broadband multilayer (e.g. 10 layers) AR coatings covering the visible band with maximal reflectivity of less than 0.5% are achievable with current commercial coating technology. In eye glow control it may be necessary to target very specific angular ranges (and possibly polarizations) which may vary significantly across the waveguide.

Magnesium Fluoride may be utilized for a single layer AR coating. In multilayer AR coatings materials such as silicon nitride, titanium dioxide and aluminum oxide may also be used in various combinations.

Previous multilayer coatings have been optimized for specified angular, wavelength, and polarization. In embodiments of this disclosure, the multilayer coatings are overlaying gratings with coating AR properties matched to the diffractive properties of the gratings.

Configurations where the input grating, the fold grating, and the output grating are EPS grating that reside in a single layer may be advantageous for manufacturing, allowing the mixture deposition, exposure, LC removal and post processing to take place on a common surface eliminating alignment issues resulting from substrate manipulation, alignment and damage risks involved informing gratings on opposing substrate surfaces. Operating on one substrate surface may also improve process throughput. Multiplexed overlapping EPS gratings may offer space savings that may also be implemented using overlapping gratings on opposing substrate faces. However, multiplexing on one surface may provide better grating registration and alignment by eliminating thickness effects and as stated above by eliminating misalignments occurring during substrate handling. Slanted EPS may provide more efficient multiplexed gratings where various types of slanted diffractive features use holographic exposure and etching.

Waveguide Architectures Including EPS Input, Fold and Output Gratings with the Fold and Output Gratings Overlapped and Multiplexed

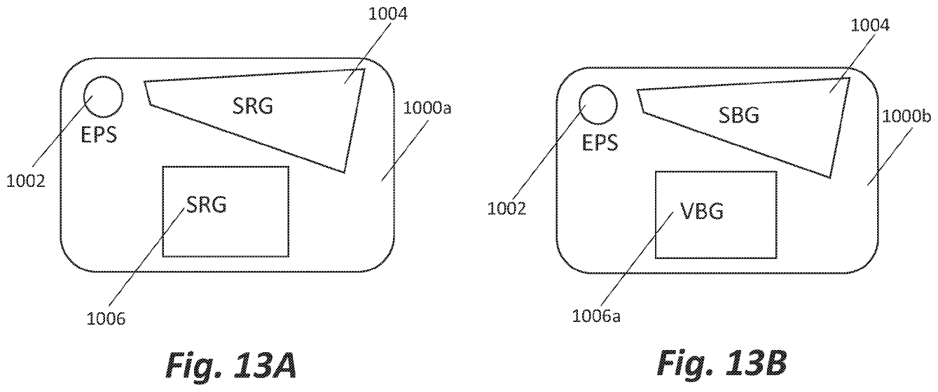

FIG. 13A schematically illustrates a plan view of a waveguide 1000a including an EPS input grating 1002, a surface relief grating (SRG) fold grating 1004, and a SRG output grating 1006 in accordance with many embodiments. EPS gratings may provide higher diffraction efficiency for both S and P light due to the ability to provide thicker modulation depth. However, EPS gratings may suffer from high haze due to high sidewall roughness. Thus, in some instances, it may be advantageous to utilize SRG gratings. SRG gratings provide low sidewall roughness which may lead to low haze. The SRG gratings may be manufactured through a nanoimprint process. However, SRG gratings may be thinner which includes thinner modulation depth which leads to poor diffraction efficiency. Further, SRG gratings manufactured through nanoimprint techniques may not be slanted. Thus, they may provide good performance for the input grating 1004 given their poor diffraction efficiency. However, they may nevertheless be useful for the fold grating 1004 and the output grating 1006 due to their lower haze. The fold grating 1004 and the output grating 1006 may not benefit from a high diffraction efficiency. Also, the fold grating 1004 and the output grating 1006 may not benefit from a slant angle. The SRG gratings may be manufactured through a nanoimprint lithography (NIL) technique.

FIG. 13B schematically illustrates a plan view of a waveguide 1000b including an EPS input grating 1002, SRG fold grating 1004, and VBG output grating 1006a. The output grating 1006a may be a VBG which may have low eyeglow. Thus, it may be advantageous to have the output grating 1006a as a VBG grating due to this low eyeglow. Eyeglow is a considerable issue for waveguide-based displays.

In some embodiments, the fold grating 1004 and the output grating 1006, 1006a may be at least partially multiplexed/overlapping. In some embodiments, the fold grating 1004 and the output grating 1006, 1006a may be fully multiplexed/overlapping. For example, these gratings may form an IDA grating.

As already discussed, the embodiments disclosed in the Bragg, Raman-Nath or hybrid Raman-Nath and Bragg regimes. Waveguides used in the embodiments disclosed may include gratings formed using RIE, NIL (Nano-Imprint Lithography is a process by means of which an SRG structure may be made by imprinting a grating structure into a resin layer) and phase separation grating formation processes.

Many basic gratings function may be used in any of the embodiments disclosed, including at least one selected from the group of: transmissive gratings reflective gratings, unslanted gratings, slanted gratings, gratings with spatially varying prescriptions, gratings with optical power, gratings with polarization selective or polarization modifying prescriptions, and gratings with diffusing properties.

Gratings used in any of the embodiments disclosed may be configured to provide at least one selected from the group of: switching between diffracting and non-diffracting states, having diffraction efficiency that is continuously electrically variable between predefined minimum and maximum efficiencies, operation in reverse mode or operation in forward mode.

Gratings used in any of the embodiments disclosed may be configure to provide a spatial variation of at least one selected from the group of: grating pitch, index modulation, grating amplitude (for EPS), average refractive index, slant angle (continuous or piecewise), holographic material composition or grating thickness.

Waveguides used in any of the embodiments disclosed may incorporate additional layers comprising at least one selected from the group of absorbing layer, bias layer, no bias layer, liquid crystal alignment layer, polarization modifying layer, passive refractive index cladding layer, electro-optical light control layer, and/or GRIN layer.

Gratings used in any of the embodiments disclosed may comprise configurations of more than one grating element comprising at least one selected from the group of: multiplexed gratings, stacked gratings, at least partially overlapping gratings, regular arrays of grating elements, IDA grating configurations based on overlapped or multiplexed gratings, tessellated gratings, stacked color specific gratings, stacked polarization specific gratings, or stacked angle-specific gratings.

Gratings used in any of the embodiments disclosed may be formed using at least one selected from the group of: material including monomers, photoinitiators, non-reacting components, material mixtures for providing high diffraction efficiency and low haze, material mixtures formulated for infrared band gratings, reactive mesogens, plastic substrates.

Gratings used in any of the embodiments disclosed may have morphologies comprising at least one selected from the group of: binary (uniform modulation), two phase (HPDLC), single phase (polymer-rich only or nanoparticle-rich only), coatings for higher effective refractive index and surface roughness reduction, other coatings for reducing haze, dopants within a polymer grating structure, and polymer grating structures from a plurality of polymer layers.

Gratings used in any of the embodiments disclosed may have geometries comprising at least one selected from the group of: binary, sinusoidal, ashing-modified, Fourier synthesized, slanted, RKV, chirped, unslanted, photonic crystalline, pillars and Bravais lattices.

Waveguides according to the principles discussed may be configured for many different applications. In various embodiments, the waveguides can be configured for single waveguide layer color operation, single layer color, angle selective waveguide stacks, wavelength selective waveguide stacks, unwanted light directing (e.g. eyeglow, glint), polarization, angle and or wavelength selective waveguide pathways, curved waveguides, GRIN waveguides, multiple input pupils, resolution multiplication, homogenizers/despecklers, beam combiners, waveguide refractive index (inc. mixed refractive indexes for stacked waveguides).

Although only a few embodiments of the invention have been described in detail, it should be appreciated that the invention may be implemented in many other forms without departing from the spirit or scope of the invention. For example, embodiments such as enumerated below are contemplated:

Clause 1. A waveguide based display comprising: an optically transparent substrate; an input grating comprising an evacuated periodic structure (EPS) supported by the substrate, wherein the input grating diffracts light into total internal reflection (TIR) within the substrate; a fold grating comprising an EPS or a volume Bragg grating (VBG), wherein the fold grating receives the TIR light and expands the TIR light in a first direction; and an output grating comprising an EPS or a VBG, wherein the output grating receives the expanded light and outputs the light, wherein the input grating is spatially separated from the fold grating and the output grating.

Clause 2. The display of clause 1, wherein the output grating expands light in a second direction different from the first direction.

Clause 3. The display of clause 2, wherein the first direction and the second direction are orthogonal

Clause 4. The display of clause 1, wherein fold grating and the output grating are spatially separated from each other.

Clause 5. The display of clause 4, wherein the fold grating and the output grating are both VBGs.

Clause 6. The display of clause 4, wherein the fold grating is an EPS and the output grating is a VBG.

Clause 7. The display of clause 1, wherein the fold grating and the output grating are both EPSs.

Clause 8. The display of clause 7, wherein the fold grating is formed on the same side of the substrate as the input grating and the output grating is formed on the opposite side of the substrate from the input grating and the fold grating.

Clause 9. The display of clause 7, wherein the fold grating is formed on the opposite side of the substrate as the input grating and the output grating is formed on the same side of the substrate as the input grating.

Clause 10. The display of clause 7, wherein the input grating, the fold grating, and the output grating are all formed on the same side of the substrate.

Clause 11. The display of clause 10, further comprising an anti-reflection coating positioned on an opposite side of the substrate from the input grating, the fold grating, and the output grating.

Clause 12. The display of clause 1, wherein the fold grating and the output grating at least partially overlap to form an overlapping region.

Clause 13. The display of clause 12, wherein the overlapping portions of the fold grating and the output grating are on different layers.

Clause 14. The display of clause 13, wherein the fold grating and output grating are both EPSs and the fold grating is positioned on one side of the substrate and the output grating is formed on an opposite side of the substrate.

Clause 15. The display of clause 12, wherein the fold grating and the output grating are formed on the same layer such that the overlapping region is a multiplexed region.

Clause 16. The display of clause 15, wherein the fold grating and output grating are both VBGs.

Clause 17. The display of clause 16, further comprising a bottom substrate, wherein the fold grating and the output grating are formed between the substrate and the bottom substrate and the input grating is formed the opposite side of the substrate from the fold grating and the output grating.

Clause 18. The display of clause 17, further comprising an anti-reflection layer disposed on the bottom substrate.

Clause 19. The display of clause 15, wherein the fold grating and output grating are both EPSs.

Clause 20. The display of clause 19, wherein the input grating, the fold grating, and the output grating are all formed on the same side of the substrate.

Clause 21. The display of clause 20, further comprising an anti-reflection coating disposed on the opposite side of the substrate from the input grating, the fold grating, and the output grating.

Clause 22. The display of clause 21, wherein the input grating, the fold grating, and the output grating are positioned on the world-side of the substrate and the anti-reflection coating is disposed on the eye-side of the substrate.

Clause 23. The display of clause 12, wherein the fold grating and the output grating fully overlap to form an integrated dual expansion (IDA) grating.

Clause 24. The display of clause 1, wherein the EPS comprises: a plurality of polymer regions; and air gaps between adjacent portions of the plurality of polymer regions.

Clause 25. The display of clause 24, wherein the EPS further comprises an atomic layer deposition (ALD) coating on the plurality of polymer regions.

Clause 26. The display of clause 24, wherein the EPS further comprises an optical layer between the substrate and plurality of polymer regions.

Clause 27. The display of clause 26, wherein the optical layer forms a homogenous structure with the plurality of polymer regions.

Clause 28. The display of clause 1, wherein the VBG of the fold grating or the output grating comprises: a plurality of polymer regions; liquid crystal regions between adjacent portions of the plurality of polymer regions.

Clause 29. The display of clause 1, wherein the fold grating is a dual interaction grating.

### Doctrine of Equivalents

While V the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A waveguide based display comprising:
an optically transparent substrate;
an input grating comprising an evacuated periodic structure (EPS) supported by the substrate, wherein the input grating diffracts light into total internal reflection (TIR) within the substrate;
a fold grating comprising an EPS or a volume Bragg grating (VBG), wherein the fold grating receives the TIR light and expands the TIR light in a first direction; and
an output grating comprising an EPS or a VBG, wherein the output grating receives the expanded light and outputs the light,
wherein the input grating is spatially separated from the fold grating and the output grating.

2. The display of claim 1, wherein the output grating expands light in a second direction different from the first direction.

3. The display of claim 2, wherein the first direction and the second direction are orthogonal.

4. The display of claim 1, wherein fold grating and the output grating are spatially separated from each other.

5. The display of claim 4, wherein the fold grating and the output grating are both VBGs.

6. The display of claim 4, wherein the fold grating is an EPS and the output grating is a VBG.

7. The display of claim 1, wherein the fold grating and the output grating are both EPSs.

8. The display of claim 7, wherein the fold grating is formed on the same side of the substrate as the input grating and the output grating is formed on the opposite side of the substrate from the input grating and the fold grating.

9. The display of claim 7, wherein the fold grating is formed on the opposite side of the substrate as the input grating and the output grating is formed on the same side of the substrate as the input grating.

10. The display of claim 7, wherein the input grating, the fold grating, and the output grating are all formed on the same side of the substrate.

11. The display of claim 10, further comprising an anti-reflection coating positioned on an opposite side of the substrate from the input grating, the fold grating, and the output grating.

12. The display of claim 1, wherein the fold grating and the output grating at least partially overlap to form an overlapping region.

13. The display of claim 12, wherein the overlapping portions of the fold grating and the output grating are on different layers.

14. The display of claim 13, wherein the fold grating and output grating are both EPSs and the fold grating is positioned on one side of the substrate and the output grating is formed on an opposite side of the substrate.

15. The display of claim 12, wherein the fold grating and the output grating are formed on the same layer such that the overlapping region is a multiplexed region.

16. The display of claim 15, wherein the fold grating and output grating are both VBGs.

17. The display of claim 16, further comprising a bottom substrate, wherein the fold grating and the output grating are formed between the substrate and the bottom substrate and the input grating is formed the opposite side of the substrate from the fold grating and the output grating.

18. The display of claim 17, further comprising an anti-reflection layer disposed on the bottom substrate.

19. The display of claim 15, wherein the fold grating and output grating are both EPSs.

20. The display of claim 19, wherein the input grating, the fold grating, and the output grating are all formed on the same side of the substrate.

21. The display of claim 20, further comprising an anti-reflection coating disposed on the opposite side of the substrate from the input grating, the fold grating, and the output grating.

22. The display of claim 21, wherein the input grating, the fold grating, and the output grating are positioned on the world-side of the substrate and the anti-reflection coating is disposed on the eye-side of the substrate.

23. The display of claim 12, wherein the fold grating and the output grating fully overlap to form an integrated dual expansion (IDA) grating.

24. The display of claim 1, wherein the EPS comprises:
a plurality of polymer regions; and
air gaps between adjacent portions of the plurality of polymer regions.

25. The display of claim 24, wherein the EPS further comprises an atomic layer deposition (ALD) coating on the plurality of polymer regions.

26. The display of claim 24, wherein the EPS further comprises an optical layer between the substrate and plurality of polymer regions.

27. The display of claim 26, wherein the optical layer forms a homogenous structure with the plurality of polymer regions.

28. The display of claim 1, wherein the VBG of the fold grating or the output grating comprises:
a plurality of polymer regions; and
liquid crystal regions between adjacent portions of the plurality of polymer regions.

29. The display of claim 1, wherein the fold grating is a dual interaction grating.
